(19) United States
(12) Patent Application Publication
(10) Pub. No.: US 2015/0083657 A1
(43) Pub. Date: Mar. 26, 2015

(54) MEMBRANE AND METHOD FOR MAKING THE SAME

(71) Applicants: Su Lu, Shanghai (CN); Zhen Liu, Shanghai (CN); Wenqing Peng, Shanghai (CN); Bing Zhang, Shanghai (CN); Hua Li, Shanghai (CN); Chen Wang, Shanghai (CN); Yun Peng, Shanghai (CN); Qingshan Jason Niu, Excelsior, MN (US)

(72) Inventors: Su Lu, Shanghai (CN); Zhen Liu, Shanghai (CN); Wenqing Peng, Shanghai (CN); Bing Zhang, Shanghai (CN); Hua Li, Shanghai (CN); Chen Wang, Shanghai (CN); Yun Peng, Shanghai (CN); Qingshan Jason Niu, Excelsior, MN (US)

(73) Assignee: General Eletric Company, Schenectady, NY (US)

(21) Appl. No.: 14/126,719

(22) PCT Filed: Jun. 14, 2012
(86) PCT No.: PCT/US12/42339

§ 371 Date: Dec. 16, 2013

(30) Foreign Application Priority Data
Jun. 22, 2011 (CN) 201110168940.8

(51) Int. Cl. B01D 71/68; B01D 67/00; B01D 71/60; B01D 69/12

(52) U.S. Cl. CPC B01D 71/68; B01D 69/125; B01D 67/0006; B01D 71/60
USPC 210/489; 427/244

(57) ABSTRACT

A membrane comprises: a porous base membrane; a polyol layer comprising polyols and a metalorganic compound; and a polyamide film layer sandwiched between the porous base membrane and the polyol layer. A method of making the membrane is also described.

### BACKGROUND

The present invention relates to membranes and methods of making membranes.

A wide variety of thin film membranes are known to be useful in the purification of fluids comprising solutes, for example the treatment of waste water and the purification of natural water. Japanese patent application publication No. 2010-188282 is directed to a membrane comprising a supporting lamella and a polymer film comprising polyvinyl alcohol cross-linked by organic titanium and formed on the supporting lamella. The membrane of the Japanese patent application publication No. 2010-188282 is loose with relatively bigger pores and is thus not desirable in many application environments.

Another kind of thin film membranes are prepared by performing an interfacial polymerization of a polyacid chloride in a water immiscible organic solvent with a polyamine in an aqueous solution on a surface of a porous base membrane. The resultant polyamide is deposited as a thin film on one surface of the porous base membrane. Such membranes are more desirable in many application environments than the membrane of the Japanese patent application publication No. 2010-188282 because of the densities thereof and are often referred to as composite membranes because of the presence of at least two layers in membrane structure, which are the porous base membrane and the interfacially prepared polyamide film layer.

To improve performances of the composite membranes, polyols, such as polyvinyl alcohol, are coated on the interfacially prepared polyamide film layer and are cross-linked by various cross-linking materials. Despite the technical excellence of many recent advances in composite membrane technology, improvements are still being sought in light of the growing demands on the world's water supplies.

There is a need for new membrane compositions and methods that can provide membranes having superior performance characteristics.

### BRIEF DESCRIPTION

In one aspect, the present invention relates to a membrane comprising: a porous base membrane; a polyol layer comprising polyols and a metalorganic compound; and a polyamide film layer sandwiched between the porous base membrane and the polyol layer.

In another aspect, the present invention is related to a method of making a membrane, comprising: providing a porous base membrane; providing a polyamide film layer on the porous base membrane by interfacial polymerization; and coating a polyol layer on the polyamide film layer, the polyol layer comprising polyols and a metalorganic compound.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Moreover, the suffix “(s)” as used herein is usually intended to include both the singular and the plural of the term that it modifies, thereby including one or more of that term.

Any numerical value ranges recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, from 20 to 80, or from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The membrane according to embodiments of the present invention may be a reverse osmosis membrane used to treat wastewater, seawater, brackish water, etc. In some embodiments of the present invention, the porous base membrane comprises at least one of polysulfone, polyethersulfone, polyester, polyphenyleneoxide, polyphenylenesulfide, polyvinyl chloride, polyacrylonitrile, polyvinylidine fluoride, polytetrafluoroethylene, polycarbonate, polyimide, polyetherimide, polyetherketone, cellulose, acetyl cellulose, nitrocellulose and polyetheretherketone.

The porous base membrane is typically configured as a film having two surfaces. The thickness of the porous base membrane may vary but should be sufficient to provide a composite membrane which can withstand the operation conditions present in a fluid purification device or water treatment device. In some embodiments, the porous base membrane has a thickness in a range from about 10 micrometers to about 500 micrometers. In some embodiments, the porous base membrane has a thickness in a range from about 20 micrometers to about 250 micrometers. In some embodiments, the porous base membrane has a thickness in a range from about 40 micrometers to about 100 micrometers.

The polyamide film layer may be formed on one of the two surfaces of the porous base membrane affording a composite membrane having a surface coated with the polyamide and an untreated surface. The polyamide film layer provides for selective transmission of water across the composite membrane while inhibiting the transmission of solute species across the composite membrane, so the surface of the composite membrane upon which the polyamide is disposed is frequently referred to as the “active” surface of the composite membrane. By analogy, the untreated surface of the porous base membrane retains the transmission characteristics of the original base membrane and is frequently referred to as the “passive” surface of the composite membrane.

The polyamide film layer is an interfacial polymerization product of polyamine and at least one of polyfunctional aromatic acid halide and polyfunctional alicyclic acid halide.

Examples of polyfunctional aromatic acid halide and polyfunctional alicyclic acid halide may be polyacid chlorides. Suitable polyacid chlorides include but are not limited to trimesoyl chloride, terephthaloyl chloride, isophthaloyl chloride, trimesic acid chloride, succinic acid diacid chloride, glutaric acid diacid chloride, adipic acid diacid chloride, trans cyclohexane-1,4-dicarboxylic acid diacid chloride, cis-cyclohexane-1,4-dicarboxylic acid diacid chloride, the triacid chloride of Kemp's triacid, and mixtures comprising two or more of these polyacid chlorides.

Suitable polyamines include but are not limited to n-phenylenediamine, para-phenylene diamine (ppd), meta-phenylene diamine (mpd), 4,4′-diaminobiphenyl, ethylene diamine, 1,3-propane diamine, 1,6-hexanediamine, 1,10-decanediamine, 4,4′-diaminodiphenyl sulfone, 1,3,5 -triaminobenzene, piperazine, cis-1,3,5-cyclohexanetriamine, and mixtures comprising two or more of these polyamines.

Given the porous nature of the porous base membrane, the polyamide may penetrate at least a portion of the internal volume of the porous base membrane and need not be confined strictly to the surface of the porous base membrane. This is particularly true in embodiments in which the composite membrane is prepared by contacting one surface of the porous base membrane with the aqueous and organic solutions needed to effect an interfacial polymerization of a polyamine with a polyacid halide. The interfacial polymerization zone may include at least a portion of the internal volume of the porous base membrane.

The polyol layer is coated on the polyamide film layer. In the context of the present invention, “polyol” means a polymer containing repeating units having hydroxyl functionality. The polyol may have a weight average molecular weight in a range of from about 500 to about 500,000. Exemplary polyols include but are not limited to cellulose, starch, dextrin, pyrodextrin, alginate, glycogen, inulin, furcellaran, agar, carrageenan, microbial gum, locust bean gum, fucoidan, guar, laminaran, gum arabic, ghatti gum, karaya gum, tragacanth gum, okra gum, tamarind gum, xanthan, scleroglucan, psyllium gum, pectin, dextran, methylcellulose, ethylcellulose, hydroxyethylcellulose, hydroxypropylcellulose, chitin carboxymethyl cellulose, polyvinyl alcohol and chitosan.

“Metalorganic compound” referred to herein may be any compounds containing metals and organic ligands but lacking direct metal-carbon bonds, that are usable as cross-linkers for polyols. Typical examples of metalorganic compounds are metal acetylacetonates and metal alkoxides. The metalorganic compound may be soluble in water or other solvents miscible with water. Particular examples of the metalorganic compound include but are not limited to organic titanates and zirconates commercially available as Tyzor®, such as dihydroxybis(ammonium lactato)titanium(IV) (C₆H₁₈N₂O₈Ti, CAS No.: 65104-06-5), tetrakis(triethanolaminato)zirconium(IV) ([(HOCH₂CH₂)₂NCH₂CH₂O]₄Zr, CAS No.: 101033-44-7), titanium bis(triethanolamine)diisopropoxide (C₁₈H₄₂N₂O₈Ti, CAS No.: 36673-16-2), triethanolamine orthotitanate (C₆H₁₃NO₄Ti, CAS No.: 10442-11-2), zirconium lactate (C₁₂H₂₀O₁₂Zr, CAS No.: 60676-90-6), titanium diisopropoxide bis(acetylacetonate) (C₁₆H₂₈O₆Ti, CAS No.: 17927-72-9), diisopropoxy-bisethylacetoacetatotitanate (C₁₈H₃₂O₈Ti, CAS No.: 27858-32-8), tetrabutyl zirconate (Zr(OC₄H₉)₄, CAS No.: 1071-76-7), tetrapropyl zirconate (Zr(OCH₂CH₂CH₃)₄, CAS No.: 23519-77-9), and titanium (IV) (triethanolaminato) isopropoxide (C₉H₁₉NO₃Ti, CAS No.: 74665-17-1). In some embodiments, the metalorganic compound may be at least one of alkoxy titanate and alkoxy zirconate.

In some embodiments, the polyol is polyvinyl alcohol and the metalorganic compound is titanium (IV) (triethanolaminato) isopropoxide. In some embodiments, a molar ratio of titanium (IV) (triethanolaminato) isopropoxide to hydroxyl groups of polyvinyl alcohol is in a range of from greater than 0 to about 2:1, from about 1.6:100 to about 16:100, or from about 8:100 to about 16:100. In some embodiments, a molar ratio of titanium (IV) (triethanolaminato) isopropoxide to hydroxyl groups of polyvinyl alcohol is about 8:100 or about 16:100.

The preparation of the polyol layer is typically carried out at a temperature in a range from about 0° C. to about 100° C. In some embodiments, the preparation of the polyol layer is carried out at a temperature in a range from about 5° C. to about 90° C. In some embodiments, the preparation of the polyol layer is carried out at a temperature in a range from about 10° C. to about 80° C.

### EXAMPLES

The following examples are included to provide additional guidance to those of ordinary skill in the art in practicing the claimed invention. Accordingly, these examples do not limit the invention as defined in the appended claims.

A membrane was prepared by interfacial polymerization of m-phenylenediamine and trimesic acid chloride on a microporous polysulfone porous base membrane and was sufficiently washed and dried.

Multiple samples of the membrane were soaked in deionized water overnight before they were immersed in a 5 wt % glycerol solution for 4 minutes, respectively. Excessive glycerol was removed by airknife in 8 seconds. A solution comprising 0.5 wt % or 1 wt % PVA (from Sigma-Aldrich Corp., St. Louis, Mo., USA, cas: 9002-89-5, Mw: 146,000˜186,000, hydrolysis degree: 99%) alone or in combination with different ratios of titanium (IV) (triethanolaminato) isopropoxide solution (from Sigma-Aldrich Corp., St. Louis, Mo., USA, cas: 74665-17-1), oxalaldehyde (from Sinopharm Chemical Reagent Co., Ltd., Shanghai, China, cas: 107-22-2), or zirconium ammonium carbonate (from Sigma-Aldrich Corp., St. Louis, Mo., USA, cas: 12616-24-9) was dip coated onto the membrane surface and was retained for 15 seconds. When oxalaldehyde was used, the pH value of the coating solution was pre-adjusted by citric acid at ˜3. Excessive solution was removed by airknife in 8 seconds. Next, the membrane was dried in an oven at 100° C. for 2 minutes. As a result, uniform coated films were formed.

The fluxes and rejections of membrane samples before and after different coatings were respectively evaluated using a 2000 ppm sodium chloride aqueous solution at a pressure of 225 psi. The data was collected 1 hour later and are shown in table 1 below. The flux (g/(s-cm²-atm)×100000) was calculated as follows: permeate mass/(time x membrane area x net driven pressure)×100000, and the rejection in table 1 was calculated as follows: (1-(permeate conductance)/(feed conductance))×100%.

TABLE 1

| | Concentration | weight ratio | Molar ratio of | Flux (g/(s- | |
|---|---|---|---|---|---|
| | of PVA | of cross-linker | cross-linker | cm²-atm) × | |
| membrane | (wt %) | to PVA | to OH groups | 100000) | Rejection |
| before coating | / | / | / | 12.2 | 97.0% |
| coated with PVA | 0.5 | / | / | 6.2 | 98.6% |
| coated with PVA- | | 10.0% | 1.60% | 7.4 | 98.7% |
| titanium (IV) | | 50.0% | 8.00% | 8.5 | 98.4% |
| (triethanolaminato) | | 100.0% | 16.00% | 9.4 | 98.4% |
| isopropoxide | | | | | |
| coated with PVA- | | 2.0% | 1.60% | 8.7 | 99.0% |
| oxalaldehyde | | 10.0% | 8.00% | 7.3 | 99.0% |
| | | 20.0% | 16.00% | 7.4 | 99.1% |
| coated with PVA- | | 30.0% | | 7.2 | 99.0% |
| zirconium | | 60.0% | | 7 | 98.7% |
| ammonium | | 100.0% | | 6.8 | 98.5% |
| carbonate | | | | | |
| before coating | / | / | / | 13.1 | 86.9% |
| coated with PVA | 1 | / | / | 6.7 | 93.3% |
| coated with PVA- | | | 1.60% | 7.1 | 92.9% |
| titanium (IV) | | | 8% | 7.5 | 92.5% |
| (triethanolaminato) | | | 16% | 8.0 | 92.0% |
| isopropoxide | | | | | |
| coated with PVA- | | | 1.60% | 7.4 | 92.6% |
| zirconium | | | 8% | 7.3 | 92.7% |
| ammonium | | | 16% | 7.9 | 92.1% |
| carbonate | | | 32% | 7.7 | 92.3% |
| coated with PVA- | | | 1.60% | 6.4 | 93.6% |
| oxalaldehyde | | | 8% | 5.2 | 94.8% |
| | | | 16% | 4.3 | 95.7% |
| | | | 32% | 4.5 | 95.5% |

It can be seen from table 1 above, when increasing the ratios of different cross-linkers to PVA (or OH groups of PVA), only the fluxes of the membrane samples coated with titanium (IV) (triethanolaminato) isopropoxide cross-linked PVA consistently increased while the fluxes of the membrane samples coated with PVA using the other two cross-linkers (zirconium ammonium carbonate and oxalaldehyde) mostly decreased.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A membrane comprising:
a porous base membrane;
a polyol layer comprising polyols and a metalorganic compound; and
a polyamide film layer sandwiched between the porous base membrane and the polyol layer.

2. The membrane of claim 1, wherein the polyol layer comprises at least one of cellulose, starch, dextrin, pyrodextrin, alginate, glycogen, inulin, furcellaran, agar, carrageenan, microbial gum, locust bean gum, fucoidan, guar gum, laminaran, gum arabic, ghatti gum, karaya gum, tragacanth gum, okra gum, tamarind gum, xanthan, scleroglucan, psyllium gum, pectin, dextran, methylcellulose, ethylcellulose, hydroxyethylcellulose, hydroxypropylcellulose, chitin carboxymethyl cellulose, polyvinyl alcohol and chitosan.

3. The membrane of claim 1, wherein the metalorganic compound comprises at least one of dihydroxybis(ammonium lactato)titanium(IV) (C₆H₁₈N₂O₈Ti, CAS No.: 65104-06-5), tetrakis(triethanolaminato)zirconium(IV) ([(HOCH₂CH₂)₂NCH₂CH₂O]₄Zr, CAS No.: 101033-44-7), titanium bis(triethanolamine)diisopropoxide (C₁₈H₄₂N₂O₈Ti, CAS No.: 36673-16-2), triethanolamine orthotitanate (C₆H₁₃NO₄Ti, CAS No.: 10442-11-2), zirconium lactate (C₁₂H₂₀O₁₂Zr, CAS No.: 60676-90-6), titanium diisopropoxide bis(acetylacetonate) (C₁₆H₂₈O₆Ti, CAS No.: 17927-72-9), diisopropoxy-bisethylacetoacetatotitanate (C₁₈H₃₂O₈Ti, CAS No.: 27858-32-8), tetrabutyl zirconate (Zr(OC₄H₉)₄, CAS No.: 1071-76-7), tetrapropyl zirconate (Zr(OCH₂CH₂CH₃)₄, CAS No.: 23519-77-9), and titanium (IV) (triethanolaminato) isopropoxide (C₉H₁₉NO₃Ti, CAS No.: 74665-17-1).

4. The membrane of claim 1, wherein the metalorganic compound is at least one of an alkoxy titanate and an alkoxy zirconate.

5. The membrane of claim 1, wherein the porous base membrane comprises at least one of polysulfone, polyethersulfone, polyester, polyphenyleneoxide, polyphenylenesulfide, polyvinyl chloride, polyacrylonitrile, polyvinylidine fluoride, polytetrafluoroethylene, polycarbonate, polyimide, polyetherimide, polyetherketone, cellulose, acetyl cellulose, nitrocellulose and polyetheretherketone.

6. The membrane of claim 1, wherein the polyamide film layer is an interfacial polymerization product of polyfunctional aromatic amine and at least one of polyfunctional aromatic acid halide and polyfunctional alicyclic acid halide.

7. The membrane of claim 1, wherein the polyol layer comprises polyvinyl alcohol cross-linked by titanium (IV) (triethanolaminato) isopropoxide.

8. The membrane of claim 7, wherein a molar ratio of titanium (IV) (triethanolaminato) isopropoxide to hydroxyl groups of polyvinyl alcohol is in a range of from greater than 0 to about 2:1.

9. The membrane of claim 7, wherein a molar ratio of titanium (IV) (triethanolaminato) isopropoxide to hydroxyl groups of polyvinyl alcohol is in a range of from about 1.6:100 to about 16:100.

10. The membrane of claim 7, wherein a molar ratio of titanium (IV) (triethanolaminato) isopropoxide to hydroxyl groups of polyvinyl alcohol is in a range of from about 8:100 to about 16:100.

11. The membrane of claim 7, wherein a molar ratio of titanium (IV) (triethanolaminato) isopropoxide to hydroxyl groups of polyvinyl alcohol is about 8:100.

12. The membrane of claim 7, wherein a molar ratio of titanium (IV) (triethanolaminato) isopropoxide to hydroxyl groups of polyvinyl alcohol is about 16:100.

13. A method of making a membrane, comprising:
providing a porous base membrane;
providing a polyamide film layer on the porous base membrane by interfacial polymerization; and
coating a polyol layer on the polyamide film layer, the polyol layer comprising polyol and a metalorganic compound.

14. The method of claim 13, wherein the porous base membrane comprises at least one of polysulfone, polyethersulfone, polyester, polyphenyleneoxide, polyphenylenesulfide, polyvinyl chloride, polyacrylonitrile, polyvinylidine fluoride, polytetrafluoroethylene, polycarbonate, polyimide, polyetherimide, polyetherketone, cellulose, acetyl cellulose, nitrocellulose and polyetheretherketone, and wherein the polyamide film layer is an interfacial polymerization product of polyamine and at least one of polyfunctional aromatic acid halide and polyfunctional alicyclic acid halide.

15. The method of claim 13, further comprising: contacting the membrane with glycerol before coating the polyol layer and after providing the polyamide layer.

16. The method of claim 13, wherein the polyol layer comprises polyvinyl alcohol cross-linked by an organic titanate.

17. The method of claim 16, wherein the organic titanate is an alkoxy titanate.

18. The method of claim 16, wherein the organic titanate is titanium (IV) (triethanolaminato) isopropoxide.

19. The method of claim 18, wherein a molar ratio of titanium (IV) (triethanolaminato) isopropoxide to hydroxyl groups of polyvinyl alcohol is in a range of from greater than 0 to about 2:1.

20. The method of claim 18, wherein a molar ratio of titanium (IV) (triethanolaminato) isopropoxide to hydroxyl groups of polyvinyl alcohol is about 8:100 or about 16:100.
